(19) United States
(12) Patent Application Publication
(10) Pub. No.: US 2026/0115797 A1
(43) Pub. Date: Apr. 30, 2026

(54) SELECTIVE LASER SINTERING WITH AREA EXPOSURE LOCALIZED HEATING

(71) Applicant: GM Global Technology Operations LLC, Detroit, MI (US)

(72) Inventors: Paul J. Wolcott, Macomb, MI (US); Adam McFarland, Royal Oak, MI (US)

(21) Appl. No.: 18/931,764

(22) Filed: Oct. 30, 2024

(51) Int. Cl. B22F 12/13; B22F 10/28; B22F 12/63; B28B 1/00; B29C 64/153; B29C 64/295; B33Y 10/00; B33Y 30/00

(52) U.S. Cl. CPC B22F 12/13; B22F 10/28; B28B 1/001; B29C 64/153; B29C 64/295; B33Y 10/00; B33Y 30/00; B22F 12/63

(57) ABSTRACT

A selective heating system for heating a layer of print material on a print bed of a selective laser sintering printer includes a computing module, a light source and a lens. The computing module stores print patterns to print a three-dimensional object. The light source emits light corresponding to the print patterns. The lens focuses light corresponding to the print patterns on to the print material on the print bed.

### INTRODUCTION

The present disclosure relates to additive manufacturing and more particularly, to systems and methods for selective laser sintering (SLS) a powder to produce a three-dimensional (3D) part.

Selective laser sintering is a process of fusing print material, usually powder, layer by layer to build a 3D object. Selective laser sintering printers use lasers, lamps, and/or resistive heating beds to heat the powder, and lasers to fuse layers of powder to create a 3D printed object.

Typically, all the print material on the print bed is heated just below the melting temperature of the print material using heating coils or infrared lamps. The print material is kept at the heated temperature throughout the print to make it easier for the laser to melt the thermoplastic powder, thus, reducing the amount of energy needed to melt the thermoplastic powder and to prevent the printed part from warping due to temperature gradients. Once heated, the printing process commences. The thermoplastic powder is spread using a spreader or a roller, creating a thin uniform layer on the build platform then the laser selectively heats up the thermoplastic powder in selected sections of the build platform to melt the powder in a defined geometry. The printing process is repeated with the part getting taller with each layer. Un-sintered print material accumulates and encases the 3D printed part. The un-sintered print material is removed after printing is completed. A percentage of the un-sintered print material that has been heated just below the melting temperature of the print material is unusable for future print jobs and must be discarded. The percentage of print material that must be discarded may range between 20% to 100%, which amounts to considerable waste and increases the cost of producing a 3D part.

Thus, while current SLS printers achieve their intended purpose, there is a need for a new and improved system and method for selective lasering sintering. A new and improved system and method that addresses the high percentage of print material waste would be especially desirable.

### SUMMARY

According to several aspects, a method for printing a three-dimensional object includes depositing print material on a print bed, spreading the deposited print material on the print bed to form a homogeneous layer of print material and projecting a print pattern on the layer of print material. The print pattern defines a cross-sectional area of the three-dimensional object. Furthermore, projecting the print pattern heats the print material within the projected print pattern from an ambient temperature to a higher temperature below a melting temperature of the print material. Additionally, the method for printing a three-dimensional object includes melting the heated print material with a laser and solidifying the melted print material to form the cross-sectional area of the three-dimensional object.

In an additional aspect of the present disclosure, spreading the deposited print material further includes rolling the deposited print material to form the homogeneous layer.

In another aspect of the present disclosure, projecting the print pattern on the layer of print material is performed with a digital light processing projector.

In another aspect of the present disclosure, projecting the print pattern on the layer of print material is performed with a laser diode array.

In another aspect of the present disclosure, melting the heated print material further includes laser heating the print material from the temperature below the melting temperature to the melting temperature of the print material.

In another aspect of the present disclosure, solidifying the layer of melted print material includes cooling the layer of melted print material.

In another aspect of the present disclosure, printing the three-dimensional object further includes printing multiple cross-sectional areas on multiple layers of print materials.

In another aspect of the present disclosure, the cross-sectional areas are formed using multiple sequential print patterns.

In another aspect of the present disclosure, the cross-sectional areas are formed using the print pattern.

According to several aspects, a selective laser sintering printer for printing a three-dimensional object includes a print bed for supporting a first layer of print material, a selective heating system for projecting a print pattern on the first layer of print material. The print pattern defines a cross-sectional area of the three-dimensional object. Projecting the print pattern heats the first layer print material within the projected print pattern from an ambient temperature to a higher temperature below a melting temperature of the print material. The printer further includes a laser for melting the heated first layer of print material to form a portion of the three-dimensional object and a print volume.

In an additional aspect of the present disclosure, the printer further includes a roller for spreading the deposited print material to form a homogeneous layer.

In another aspect of the present disclosure, the selective heating system further includes a digital light processing projector to project the print pattern on the first layer of print material.

In another aspect of the present disclosure, the printer further includes a control module. The control module includes instructions to control the laser to heat the first layer of print material from the temperature below the melting temperature to the melting temperature of the print material.

In another aspect of the present disclosure, the control module further includes instructions to change the print patterns from a first print pattern to a second print pattern when a second layer of print material is deposited on the first layer of print material on the print bed.

In another aspect of the present disclosure, the printer further includes a motor to move the print bed in a vertical direction thereby adjusting the print volume to accommodate the three-dimensional object.

According to several aspects, a selective heating system for heating a layer of print material on a print bed of a selective laser sintering printer includes a computing module that includes a processor and a memory for storage of print patterns, a light source configured to emit light corresponding to the print patterns, and a lens for receiving the emitted light corresponding to the print patterns. The lens focuses the print patterns on the layer of print material disposed on the print bed. Furthermore, the focused print patterns heat the layer of print material.

In yet another aspect of the present disclosure, the memory further includes instructions to focus the print patterns on the layer of print material to heat the layer of print material from an ambient temperature to a higher temperature below a melting temperature of the print material.

In an additional aspect of the present disclosure, the light source further includes a digital light processing projector to project the print pattern on the layer of print material.

In another aspect of the present disclosure, the light source further includes a laser diode array to project the print pattern on the layer of print material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a selective laser sintering (SLS) printer, in accordance with an embodiment of the present disclosure;

FIG. 2A is a partial top view of a print pattern projected on to a layer of print material deposited on a print bed of the SLS printer, in accordance with an embodiment of the present disclosure;

FIG. 2B is schematic illustration of a side view of the print bed having additional layers of print material successively deposited on layers of print material with some of the layers having sintered portions, in accordance with an embodiment of the present disclosure; and

FIG. 3 is a flowchart illustrating a method for printing a three-dimensional object with an SLS printer, in accordance with an embodiment of the present disclosure.

### DETAILED DESCRIPTION

The following description is merely exemplary in nature and is not intended to limit the present disclosure, application, or uses.

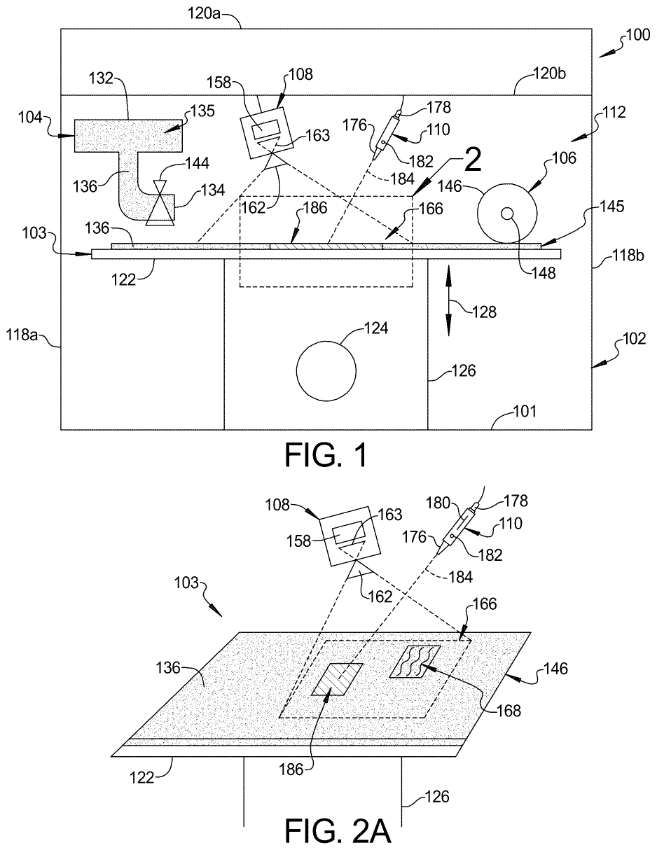

Referring to FIG. 1, a schematic illustration of the SLS printer 100 is shown, in accordance with an embodiment of the present disclosure. The printer has a print floor 101, a frame 102, a print bed assembly 103, a reservoir 104, a roller 106, selective heating system 108, a laser 110 and a print volume 112. The components of the SLS printer 100 are described in more detail below.

The print floor 101 is disposed in a horizontal plane and may be placed on a solid surface such as a manufacturing table or floor. The print floor 101 may have a rectangular or square shape as needed to support the frame 102 and the print bed assembly 103. The print floor 101 is configured to support the frame 102 and the print bed assembly 103.

The frame 102 includes vertical support members, 118a, 118b, 118c (not shown) and 118d (not shown), and horizontal members 120a, 120b (not shown), 120c (not shown) and 120d (not shown). One end of the vertical members 118a-118d are placed and secured at the corners of the perimeter of the print floor 101. The horizontal members 120a-120d are connected and secured to the other end of the vertical members 118a-118d. Thus, the horizontal members 120a-120d are located above the print bed assembly 103 and provide a means to support the components of the SLS printer 100 above the print bed assembly 103, as will be described in further detail below.

Print bed assembly 103 includes a build plate 122, a motor 124 and housing 126. The build plate 122 is used to support the three-dimensional object during printing. The build plate is supported by the housing 126. The housing 126 is supported by the print floor 101 and is expandable and collapsible in the vertical direction 128. The housing 126 is affixed in a central portion of the print floor 101 and affixed in a central portion of the build plate 122. The motor 124 is located below the build plate 122 and is coupled to the housing 126 to move the housing 126 vertically. Thus, the build plate 122 moves up and down in the vertical direction 128 by expanding and collapsing the housing 126 in the vertical direction 128.

The reservoir 104 is a funnel-like structure with an inlet 132, outlet 134 and a holding tank 135. The inlet receives a print material 136 for use during a print process. The outlet 134 is used as an exit for the print material 136 to be deposited on to the build plate 122 of the print bed assembly 103 during the printing process. The holding tank 135 is disposed between the inlet 132 and the outlet 134. The holding tank 135 holds the required amount of print material 136 necessary to print the 3D object. The outlet 134 further includes a valve 144 having a closed state and an open state. In the closed state, the valve 144 prevents the print material 136 from flowing out of the reservoir 104. The valve 144 in the open state permits the print material 136 to flow out of the reservoir 104. In an embodiment of the present disclosure the valve 144 is selectively toggleable from the closed state to the opened state to dispense print material on the print bed. The print material 136 may be made from, but not limited to, polymers such as nylon 11 and nylon 12, composite materials such as glass-filled nylon, carbon-fiber nylon, thermoplastic polyurethane, polycarbonate, polypropylene, metal powders and ceramics.

The roller 106 includes a roller body 146 and an axle 148. The roller body 146 is cylindrical and has a through-bore that runs through the length of the roller body 146 for the roller axle 148 to pass through. In an embodiment of the present disclosure the roller 106 includes a drive mechanism (not shown) that is configured to roll and press the roller body 146 along the entire build plate 122. The roller 106 is used to distribute the deposited print material 136 on the build plate 122 to form a thin, dense, homogenous layer 145. The roller 106 includes a roller body 146 and a roller axle 148.

The selective heating system 108 is supported above the build plate 122 by the horizontal members 120a-120d of the frame 102. The selective heating system 108 includes a computing module 158, a lens 162 and a light source projector 163. The computing module 158 includes a processor and a memory and is used for storage of a print pattern 164 and instructions 165. In an embodiment of the present disclosure the computing module 158 stores multiple print patterns 164 needed to print the three-dimensional object. The instructions 165 contain information on the sequence and duration for projecting the print patterns 164. The lens 162 is used to scale and project the light emitted by the light source 163. Moreover, the light source 163 receives the print pattern 164 from the computing module 158 and emits light corresponding to the print pattern 164. The print pattern 164 is then projected through the lens 162 on to the layer 145 of print material 136 on the build plate 122. In an embodiment of the present disclosure the print pattern 164 is projected for a duration of time on the print plate 122 to heat the print material 136 to a near-melting temperature. In an embodiment of the present disclosure, the selective heating system 108 is, for example, a digital light process (DLP) projector. In another embodiment of the present disclosure, the selective heating system 108, is for example, a laser diode array.

The laser 110 is supported on the horizontal members 120a-120d of the frame 102. The laser 110 includes a laser gun 176, a galvanometer 178, a control module 180, and a communication module 182. The laser gun 176 emits a laser beam 184 onto the layer 145 of print material 136. The beam 184 heats the print material 136 from the near-melting temperature to a melting temperature. The rise in temperature causes the particles of the print material 136 exposed to the laser beam 184 to sinter and fuse with neighboring particles. The galvanometer 178 orients the laser gun 176 allowing the laser gun 176 to emit the laser beam 184 at different locations on the build plate 122. The control module 182 determines and controls the orientation of the galvanometer 178. The communication module 182 communicably couples the selective heating system 108 to the laser 110. Moreover, the communication module 182 has access to the print pattern 164 and instructions 172 that are stored in the computing module 158 of the selective heating system 108. The communication module 182 is operable to send the print pattern 164 to control module 180, which uses the print pattern 164 to determine a control procedure needed to orient the laser gun 176 such that the beam 184 is emitted in the print pattern 164. The laser 110 may be, for example, a carbon laser, a fiber laser or any laser suitable to heat and melt the print material 136.

Print volume 112 defines the effective printing volume of SLS printer 100. The print volume 112 is adjustable by moving the print bed assembly 103 up or down, in the vertical direction. In an embodiment of the present disclosure, the print volume 112 increases, for example, when the print bed assembly 103 moves vertically towards the printer floor 101. Additionally, the present disclosure contemplates that the print volume 112 is adjustable to a final volume that is sufficient to contain all the layers 145 needed to complete the printing of the three-dimensional object.

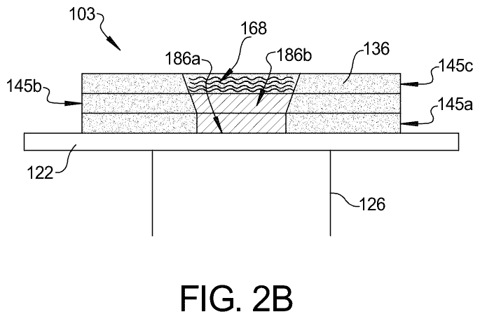

Referring now to FIG. 2A, a partial top view of the print pattern 164 projected on to a layer 145 of print material 136 that is distributed on the build plate 122 of the print bed assembly 103 is illustrated, in accordance with an embodiment of the present disclosure. The print pattern 164 defines multiple selectively heated sections 168 within the print area 166. The selectively heated sections 168 represent the cross-sectional geometry of the 3D object to be produced. The selective heating system 108 heats the selectively heated sections 168 to the near-melting temperature. The laser 110 is directed to the selectively heated sections 168 and further heats the selectively heated sections 168 to the melting temperature of the print material to form the sintered regions 186. The sintered sections 168 represent the final cross-sectional geometry of the printed object.

Referring now to FIG. 2B, schematic illustration of a first, a second and a third layer 145a-c of print material 136 deposited on the build plate 122 is shown, in accordance with an embodiment of the present disclosure. The first layer 145a has a first sintered region 186a defined by a first print pattern of the print pattern 164 projected by the selective heating system 108. The second layer 145b has a second sintered region 186b defined by a second print pattern of the print pattern 164 projected by the selective heating system 108. The third layer 145c has a selectively heated section 168 defined by a third print pattern of the print pattern 164 projected by the selective heating system 108. The first and second sintered regions 186a and 186b, and the selectively heated section 168 are bordered by unheated print material 136 that will be removed when the print is completed. The first sintered region 186a and the second sintered region 186b are fused to form a portion of the 3D object. The selectively heated section 168 in the third layer 145c is heated to a temperature below the melting point of the print material 136 by the selective heating system 108 without heating the print material 136 boarding the selectively heated section 168.

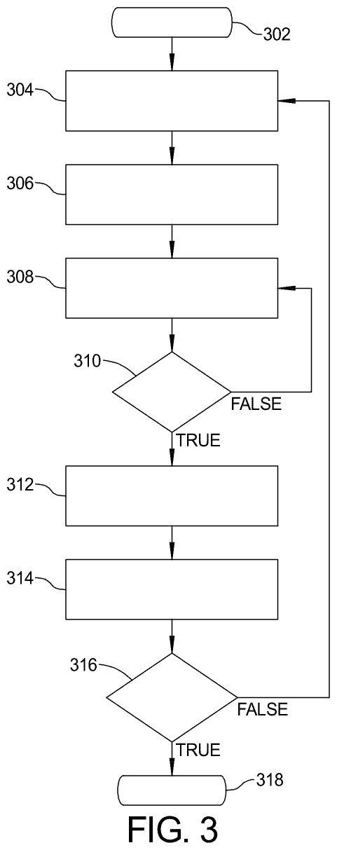

Referring to FIG. 3, a method for printing a three-dimensional object with the SLS printer 100 is shown generally as 300 in accordance with an embodiment of the present disclosure. In the present disclosure, the method 300 enables the printer 100 to print the three-dimensional object to completion. Furthermore, the method 300 and the systems described above enable printing of complex parts, including, but not limited to, fasteners, cylindrical shafts, among other objects.

In an embodiment of the present disclosure, at block 302, the method 300 for selective laser sinter printing begins.

At block 304, with additional reference to FIG. 1, the print material 136 is deposited from the reservoir 104 onto the build plate 122 of the print bed assembly 103.

At block 306, the roller 106 spreads the print material 136 evenly on the top surface 128 of the build plate 122, forming a thin dense layer 145 of the print material 136.

At block 308, with additional reference to FIGS. 1 and 2, the print pattern 164 is projected onto the layer 145. As mentioned above, projecting the print pattern 164 for a duration of time increases the temperature of the print material 136 in the selectively heated sections 168 of the print area 166 defined in the print pattern 164. The print material 136 outside of the print pattern 164 and the selectively heated sections 168 not exposed to the light source 163 of the selective heating system 108 is not heated by the selective heating system 108.

At block 310, the temperature of the print material 136 is checked. In an embodiment of the present disclosure, the temperature of the print material 136 is determined by sensing the amount of heat radiating from the selectively heated section 168. In another embodiment of the present disclosure the temperature of the print material 136 is not determined, rather, the print pattern 164 is projected on to layer 145 of print material 136 for a predetermined length of time to elevate the temperature of the print material 136 to a prescribed temperature, for example, at a near-melting temperature.

At block 312, with additional reference to FIGS. 1 and 2, the print material 136 in the selectively heated section 168 is sintered using the laser 110, forming the sintered region 186.

At block 314, with additional reference to FIG. 2, the sintered regions 186 is solidified. In an embodiment of the present disclosure, the sintered section 184 is solidified by turning off the light source projector 163 and the laser 110 allowing the print material to cool down.

At block 316, the SLS printer 100 checks whether the print process is complete. In an embodiment of the present disclosure, the printer 100 receives a notification from the computing module 158 of the light source projector 163 indicating whether there are more layers 145 to print. The print process is deemed complete when the processor and memory of the computing module 158 indicate the last layer has been dispensed, heated and sintered.

At block 318, the printing process ends.

The systems and method of the present disclosure offer several advantages. These include a significant reduction of wasted print material 136. Selectively heating the layer 145 of print material 136 in specific regions preserves the quality of print material 136 in the unheated regions, thus making the print material 136 reusable.

Selectively heating could also increase the number and variety of print materials 136 that may be used for SLS printing. For example, insulation materials such as glass-fiber absorb and retain heat, thereby making such materials unconducive for SLS printing. Advantageously, heating selected regions with the selective heating system of the present disclosure overcomes the problems that arise when SLS printing with the insulation materials.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for printing a three-dimensional object, the method comprising:
depositing print material on a print bed;
spreading the deposited print material on the print bed to form a homogeneous layer of print material;
projecting a print pattern on the layer of print material, wherein the print pattern defines a cross-sectional area of the three-dimensional object, wherein projecting the print pattern heats the print material within the projected print pattern from a first ambient temperature to a second higher temperature below a melting temperature of the print material;
melting the heated print material with a laser; and
solidifying the melted print material forming the cross-sectional area of the three-dimensional object.

2. The method of claim 1, wherein spreading the deposited print material further comprises rolling the deposited print material to form the homogeneous layer.

3. The method of claim 1, wherein projecting the print pattern on the layer of print material is performed with a digital light processing projector.

4. The method of claim 1, wherein projecting the print pattern on the layer of print material is performed with a laser diode array.

5. The method of claim 1, wherein melting the heated print material further comprises laser heating the print material from the second temperature to the melting temperature of the print material.

6. The method of claim 5, wherein solidifying the layer of melted print material includes cooling the layer of melted print material.

7. The method of claim 2, wherein printing the three-dimensional object further includes printing a plurality of cross-sectional areas on a plurality of layers of print materials.

8. The method of claim 7, wherein the plurality of cross-sectional areas is formed using a plurality of sequential print patterns.

9. The method of claim 7, wherein the plurality of cross-sectional areas is formed using the print pattern.

10. A selective laser sintering printer for printing a three-dimensional object, the printer comprising:
a print bed for supporting a first layer of print material;
a selective heating system for projecting a print pattern on the first layer of print material, wherein the print pattern defines a cross-sectional area of the three-dimensional object, wherein projecting the print pattern heats the first layer print material within the projected print pattern from a first ambient temperature to a second higher temperature below a melting temperature of the print material;
a laser for melting the heated first layer of print material to form a portion of the three-dimensional object; and
a print volume.

11. The printer of claim 10, further comprising a roller for spreading the first layer of print material supported on the print bed to form a homogeneous layer.

12. The printer of claim 11, wherein the selective heating system further comprises a digital light processing projector to project the print pattern on the first layer of print material.

13. The printer of claim 11, wherein the selective heating system further comprises a laser diode array to project the print pattern on the first layer of print material.

14. The printer of claim 10, further comprising a control module, wherein the control module includes instructions to control the laser to heat the first layer of print material from the second temperature to the melting temperature of the print material.

15. The printer of claim 14, wherein the control module further comprises instructions to change the plurality of print patterns from a first one of the plurality of print patterns to a second one of the plurality of print patterns when a second layer of print material is deposited on the first layer of print material on the print bed.

16. The printer of claim 10, further comprising a motor to move the print bed in a vertical direction thereby adjusting the print volume to accommodate the three-dimensional object.

17. A selective heating system for heating a layer of print material on a print bed of a selective laser sintering printer, the system comprising:
a computing module, wherein the computing module includes a processor and a memory for storage of a plurality of print patterns;
a light source configured to emit light corresponding to the plurality of print patterns; and
a lens for receiving the emitted light corresponding to the plurality of print patterns, wherein the lens focuses the plurality of print patterns on the layer of print material disposed on the print bed, and wherein the focused plurality of print patterns heats the layer of print material.

18. The printer of claim 17, wherein the memory further comprises instructions to focus the plurality of print patterns on the layer of print material to heat the layer of print material from a first ambient temperature to a second higher temperature below a melting temperature of the print material.

19. The printer of claim 17, wherein the light source further comprises a laser diode array to project the plurality of print patterns on the layer of print material.

20. The printer of claim 17, wherein the light source further comprises a digital light projector to project the plurality of print patterns on the layer of print material.
